(19) United States
(12) Patent Application Publication
(10) Pub. No.: US 2015/0094151 A1
(43) Pub. Date: Apr. 2, 2015

(54) METHOD FOR PROVIDING GAME SERVICE USING AUXILIARY ITEM, SERVER FOR SAME, AND RECORDING MEDIUM

(71) Applicant: INTELLECTUAL DISCOVERY CO., LTD., Seoul (KR)

(72) Inventor: Woon Yong Kim, Suwon-si (KR)

(73) Assignee: INTELLECTUAL DISCOVERY CO., LTD., Seoul (KR)

(21) Appl. No.: 14/385,583

(22) PCT Filed: Oct. 4, 2012
(86) PCT No.: PCT/KR2012/008004

§ 371 Date: Sep. 16, 2014

(30) Foreign Application Priority Data
Jun. 29, 2012 (KR) 10-2012-0070474

(51) Int. Cl. A63F 13/35; A63F 13/55

(52) U.S. Cl. CPC A63F 13/35; A63F 13/55
USPC 463/42

(57) ABSTRACT

An exemplary embodiment of the present invention provides a game service providing method using an auxiliary item, including: by a server, providing a user terminal with an auxiliary item for assisting a main item that is necessary for the user terminal; determining whether an activation condition for activating the provided auxiliary item is satisfied; when it is determined that the activation condition is satisfied, activating a predetermined effectiveness of the auxiliary item of the user terminal; and improving an ability of the main item through the effectiveness.

### TECHNICAL FIELD

The present invention relates to a game service providing method using an auxiliary item, a server therefor, and a recoding medium, and more particularly, to a game service providing method using an auxiliary item, a server therefor, and a recoding medium, for preventing user game defection by arousing interests of users, and producing more profits.

### BACKGROUND ART

With development of network supply environments, services for providing various contents on the Internet have recently stepped out onto the stage. Among these services, services for providing game contents have been being experienced rapid growth in market expansion and supply speed.

Further, diffused demand for these game contents services causes a sharp rise in the development speed and supply speed of the game contents services. As the number of users who uses the game services has significantly increased, some free game services start to charge users for their use.

Such online-based game contents providing services are advantageous in enabling one user to play the same game with other users who are remote from the user without constraints of time and space.

As such, as the number of users who use game services through the Internet is sharply raised and charged game contents services are in progress, many portal sites and game service providers have developed various kinds of services to produce their profits.

Accordingly, game service providers have sought for a method for producing profits by performing a new type service for allowing users to keep playing games for a longer time, and preventing user game defection by arousing interests of users.

### DISCLOSURE

### Technical Problem

The present invention has been made in an effort to provide a game service providing method using an auxiliary item corresponding to a new type of service for allowing users to keep playing games for a longer time, and preventing user game defection by arousing interests of users, a server therefor, and a recoding medium.

### Technical Solution

An exemplary embodiment of the present invention provides a game service providing method using an auxiliary item, including: by a server, providing a user terminal with an auxiliary item for assisting a main item that is necessary for the user terminal; determining whether an activation condition for activating the provided auxiliary item is satisfied; when it is determined that the activation condition is satisfied, activating a predetermined effectiveness of the auxiliary item of the user terminal; and improving an ability of the main item through the effectiveness.

The activating of the predetermined effectiveness may include: when a use number of times at which the auxiliary item is to be used is determined according to a game play number of times at which a game was played, determining whether the use number of the auxiliary item remains; and, when it is determined that the use number remains, activating the effectiveness.

The activating of the predetermined effectiveness may include: when it is determined that no use number remains, not activating the effectiveness and sending a notification that no use number remains to the user terminal.

The game service providing method may further include: receiving a charging request for charging the use number from the user terminal that receives the notification; and when the charging request is received, deducting game points held by the user terminal and charging the use number.

The providing of the auxiliary item include: receiving a buying request for buying the auxiliary item from the user terminal; and providing an auxiliary item that is requested to be bought by the user terminal to the user terminal and deducting game points of the user terminal.

The deducted game points may be differently set according to types of the auxiliary item that the user terminal wants to buy.

The auxiliary item may correspond to a first auxiliary item, and, when the first auxiliary item is combined with a second auxiliary item, an effect of the first auxiliary item may be changed to an effect of the second auxiliary item.

The auxiliary item may correspond to an auxiliary item created by reusing a predetermined number of auxiliary items.

The auxiliary item may correspond to a question-mark auxiliary item, and the question-mark auxiliary item may be one of auxiliary items that are provided to the user terminal, and an attribute of the auxiliary item is not known before the auxiliary item is bought.

An attribute of the question-mark auxiliary item generated after the question-mark auxiliary item is bought may be determined based on a table showing a grade generating possibility of the question-mark auxiliary item that is pre-stored in the server.

Another exemplary embodiment of the present invention provides a server for providing a game service using an auxiliary item, including: a transceiving module configured to provide a user terminal with an auxiliary item for assisting a main item that is necessary for the user terminal; a determining module configured to whether an activation condition for activating the provided auxiliary item is satisfied; and an item managing module configured to manage the main item and the auxiliary item and, when it is determined that the activation condition is satisfied, activate a predetermined effectiveness of the auxiliary item of the user terminal and improve an ability of the main item through the effectiveness.

when a use number of times at which the auxiliary item is to be used is determined according to a game play number of times at which a game was played, the determining module may determine whether the use number of the auxiliary item remains, and when it is determined by the determining module that the use number of the auxiliary item remains, the item managing module may activate the effectiveness.

when it is determined by the determining module that no use number of the auxiliary item remains, the item managing module may not activate the effectiveness.

The transceiving module may receive a charging request for charging the use number from the user terminal, and the server further may include, when the charging request is received through the transceiving module, a charging module configured to deduct game points held by the user terminal and charge the use number.

Yet another exemplary embodiment of the present invention provides a computer readable recording medium recorded with program for executing a game service providing method, wherein the method includes: by a server, providing a user terminal with an auxiliary item for assisting a main item that is necessary for the user terminal; determining whether an activation condition for activating the provided auxiliary item is satisfied; when it is determined that the activation condition is satisfied, activating a predetermined effectiveness of the auxiliary item of the user terminal; and improving an ability of the main item through the effectiveness.

### Advantageous Effects

In accordance with a game service providing method using an auxiliary item, a server therefor, and a recoding medium according to an exemplary embodiment of the present invention, it is possible to provide game users with a new type of service for keeping playing games for a longer time, and preventing user game defection by arousing interests of the game users.

### DESCRIPTION OF THE DRAWINGS

The objects and features of the present invention will become apparent from the following description of embodiments, given in conjunction with the accompanying drawings, in which:

FIG. 1 is a schematic diagram showing the structure of a game providing system in accordance with an exemplary embodiment of the present invention.

FIG. 2 shows a server in accordance with the present exemplary embodiment.

FIG. 3 is a diagram for describing an item managing module shown in FIG. 2 in more detail.

FIG. 4 is a flowchart showing a game service providing method using an auxiliary item in accordance with the present exemplary embodiment.

FIG. 5 is a flowchart for describing step S300 of FIG. 4 in more detail.

FIG. 6 is a flowchart for describing step S100 of FIG. 4 in more detail.

FIG. 7 shows a main item in accordance with the present exemplary embodiment.

FIG. 8 shows an auxiliary item in accordance with the present exemplary embodiment.

FIG. 9 shows a main item reflected with effectiveness of the auxiliary item in accordance with the present exemplary embodiment.

FIG. 10 shows charging fees of remaining use numbers of auxiliary items in accordance with the present exemplary embodiment of the present invention.

FIG. 11 shows a holding auxiliary item list of a user terminal in accordance with the present exemplary embodiment of the present invention.

FIG. 12 is a view for describing a composition (or combination) of two or more auxiliary items in accordance with the present exemplary embodiment.

FIG. 13 is a view for describing reuse of the auxiliary item in accordance with the present exemplary embodiment of the present invention.

FIG. 14 is a view for describing a question-mark auxiliary item in accordance with the present exemplary embodiment.

FIG. 15 is a table showing a grade generating possibility of the question-mark in accordance with the present exemplary embodiment of the present invention.

### MODE FOR INVENTION

An exemplary embodiment of the present invention provides a game service providing method using an auxiliary item, including: by a server, providing a user terminal with an auxiliary item for assisting a main item that is necessary for the user terminal; determining whether an activation condition for activating the provided auxiliary item is satisfied; when it is determined that the activation condition is satisfied, activating a predetermined effectiveness of the auxiliary item of the user terminal; and improving an ability of the main item through the effectiveness.

The activating of the predetermined effectiveness may include: when a use number of times at which the auxiliary item is to be used is determined according to a game play number of times at which a game was played, determining whether the use number of the auxiliary item remains; and, when it is determined that the use number remains, activating the effectiveness.

The activating of the predetermined effectiveness may include: when it is determined that no use number remains, not activating the effectiveness and sending a notification that no use number remains to the user terminal.

The game service providing method may further include: receiving a charging request for charging the use number from the user terminal that receives the notification; and when the charging request is received, deducting game points held by the user terminal and charging the use number.

The providing of the auxiliary item include: receiving a buying request for buying the auxiliary item from the user terminal; and providing an auxiliary item that is requested to be bought by the user terminal to the user terminal and deducting game points of the user terminal.

The deducted game points may be differently set according to types of the auxiliary item that the user terminal wants to buy.

The auxiliary item may correspond to a first auxiliary item, and, when the first auxiliary item is combined with a second auxiliary item, an effect of the first auxiliary item may be changed to an effect of the second auxiliary item.

The auxiliary item may correspond to an auxiliary item created by reusing a predetermined number of auxiliary items.

The auxiliary item may correspond to a question-mark auxiliary item, and the question-mark auxiliary item may be one of auxiliary items that are provided to the user terminal, and an attribute of the auxiliary item is not known before the auxiliary item is bought.

An attribute of the question-mark auxiliary item generated after the question-mark auxiliary item is bought may be determined based on a table showing a grade generating possibility of the question-mark auxiliary item that is pre-stored in the server.

Another exemplary embodiment of the present invention provides a server for providing a game service using an auxiliary item, including: a transceiving module configured to provide a user terminal with an auxiliary item for assisting a main item that is necessary for the user terminal; a determining module configured to whether an activation condition for activating the provided auxiliary item is satisfied; and an item managing module configured to manage the main item and the auxiliary item and, when it is determined that the activation condition is satisfied, activate a predetermined effectiveness of the auxiliary item of the user terminal and improve an ability of the main item through the effectiveness.

when a use number of times at which the auxiliary item is to be used is determined according to a game play number of times at which a game was played, the determining module may determine whether the use number of the auxiliary item remains, and when it is determined by the determining module that the use number of the auxiliary item remains, the item managing module may activate the effectiveness.

when it is determined by the determining module that no use number of the auxiliary item remains, the item managing module may not activate the effectiveness.

The transceiving module may receive a charging request for charging the use number from the user terminal, and the server further may include, when the charging request is received through the transceiving module, a charging module configured to deduct game points held by the user terminal and charge the use number.

Yet another exemplary embodiment of the present invention provides a computer readable recording medium recorded with program for executing a game service providing method, wherein the method includes: by a server, providing a user terminal with an auxiliary item for assisting a main item that is necessary for the user terminal; determining whether an activation condition for activating the provided auxiliary item is satisfied; when it is determined that the activation condition is satisfied, activating a predetermined effectiveness of the auxiliary item of the user terminal; and improving an ability of the main item through the effectiveness.

Hereinafter, exemplary embodiments of the present invention will be described in detail with reference to the accompanying drawings.

In the following description, in order to clearly understand the present invention, description of a known technology regarding a characteristic of the present invention will be omitted. It is obvious that the following exemplary embodiment is a detailed description which is provided for more understanding of the present invention but does not limit the scope of the present invention. Therefore, an equivalent invention which performs the same function as the present invention may be also covered by the scope of the present invention.

In the following description, like reference numerals designate like elements having the same configuration and redundant description and description of a known technology will be omitted.

In the following description, “server” indicates a server computer to which users access to use game contents. In the case of a game which has a small capacity or a small number of users, a plurality of game programs may be operated by one server. Further, in the case of a game which has a large capacity or a large number of real time accessing members, one or more servers which operate one game may be provided depending on a function of the game.

In addition, middle ware for database or servers which perform payment processing may be connected to the server, but the description thereof will be omitted in the present invention.

In this specification, an item indicates all data that can give assistance when playing the game and can be generally understood as an item on the game

For example, in a sports game, a card item for using a character, an item for increasing a capability level of the character, an item for recovering a condition of the character, an item for increasing a capability level in the game and simultaneously for changing the appearance of the character by mounting the card to the character, and the like pertain to the items in the present invention. As such, all items that can be used by a character during the play of a game or can be used by a user to apply it to the game pertain to the items in the present invention

In an exemplary embodiment of the present invention, “communication”, “communication network” and “network” may be used to have the same meaning. The three terminologies indicate a wired or wireless local area and wide area data transmitting/receiving network through which a file is transmitted/received between a user terminal, another user terminal, and a download server.

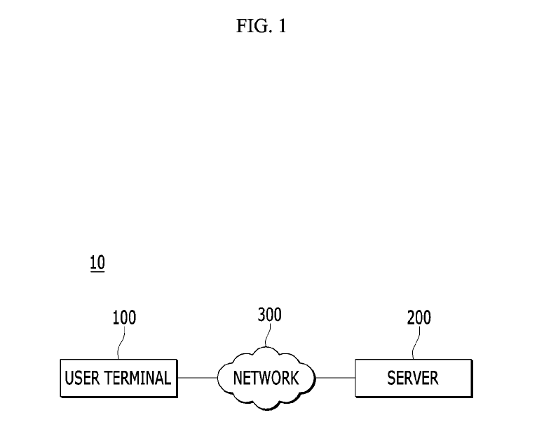

FIG. 1 is a schematic diagram showing the structure of a game providing system in accordance with an exemplary embodiment of the present invention. The game providing system 10 includes a user terminal 100, a server 200, and a network 300.

Referring to FIG. 1, the server 200 may be connected to the user terminal 100 through the network 300, may provide a game (e.g., soccer game) to the user terminal 100 through the network 300, and may provide various services (e.g., a player training service, a soccer game service, and a providing service of various items) to a user of the user terminal 100 which plays the game.

In the case of providing items related to the soccer game to the user terminal 100, the server 200 may provide a player item (e.g., a player card) and an auxiliary item (e.g., a card that increases an ability value of the player card when a predetermined condition is satisfied) for assisting the player item. In other words, the auxiliary item performs a function of assisting the player item as a main item.

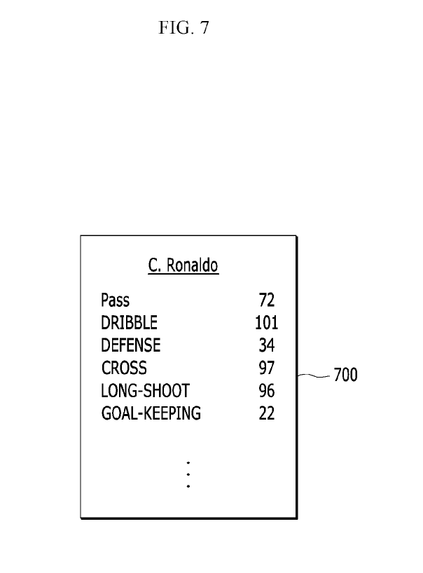

As necessary, the server 200 may provide an auxiliary item to the user terminal 100, and may improve the ability of a main item that is held by the user terminal 100 by using the auxiliary item. In this case, the auxiliary item may have an activation condition, and when the activation condition is satisfied, the corresponding auxiliary item may be activated to provide a predetermined effectiveness thereof. This will be described below with reference to FIG. 7 to FIG. 9 by using detailed examples.

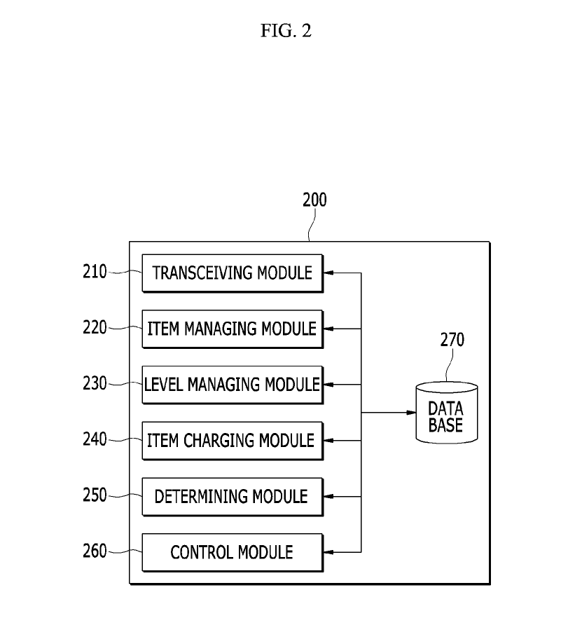

A detailed description of the server 200 will be made with reference to FIG. 2.

The user terminal 100 may maintain a connection state with the server 200 through the network 300 such as the Internet or a telephone line. For example, the user terminal 100 may correspond to a personal computer, a handheld computer, a personal digital assistant (PDA), a mobile phone, or a smart phone, and may correspond to a concept commonly naming a terminal having a predetermined calculating ability by mounting a microprocessor.

FIG. 2 shows a server in accordance with the present exemplary embodiment. The server 200 may include a transceiving module 210, an item managing module 220, a level managing module 230, an item charging module 240, a determining module 250, a control module 260, and a database 270.

It shall be obvious to a person of an ordinary skill in the art pertaining to the present invention that terms used herein ‘server’ or ‘module’ indicate a logic constituent unit, but may not serve as an constituent element that is physically recognized.

The transceiving module 210 serves to transmit and receive various data (e.g., game data and various necessary data related to a corresponding game) including item information to and from the user terminal 100.

Specifically, the transceiving module 210 serves to receive a selection request signal of an auxiliary item for assisting the performance of a main item from the user terminal 100 and serves to provide the auxiliary item for assisting the main item that is necessary for a corresponding game to the user terminal 100.

In this case, while providing the auxiliary item that is requested to be bought by the user terminal 100 thereto, the server 200 deducts the game points held by the user terminal 100.

The database 270 serves to store various data related to a corresponding game.

The item managing module 220 serves to manage main items and auxiliary items that are used for the game. In this case, the auxiliary item serves to perform a function of assisting the performance of the main items.

The determining module 250 serves to determine whether an activation condition for activating the auxiliary item provided to the user terminal 100 is satisfied.

When it is determined that the activation condition is satisfied by the determining module 250, the item managing module 220 performs a function of activating a predetermined effectiveness of the auxiliary item of the user terminal 100 to improve the ability of the main item through the effectiveness.

In the case that the item managing module 220 activates the predetermined effectiveness, when a use number of times at which the auxiliary item can be used is predetermined according to a game play number of times at which the game is played, the determining module 250 determines whether the use number of the auxiliary item remains and, if the use number of the auxiliary item remains, performs the function of activating the effectiveness.

When it is determined that no use number remains by the determining module 250, the item managing module 220 does not activate the effectiveness, and the server 200 notifies the user terminal 100 that no use number remains by the control of the control module 260.

When no use number of the auxiliary item remains, the item charging module 240 serves to charge the use number according to a request of the user terminal 100. In this case, the game points held by the user terminal 100 are deducted.

The level managing module 230 serves to manage a level of the user terminal 100 and a grade of the auxiliary item.

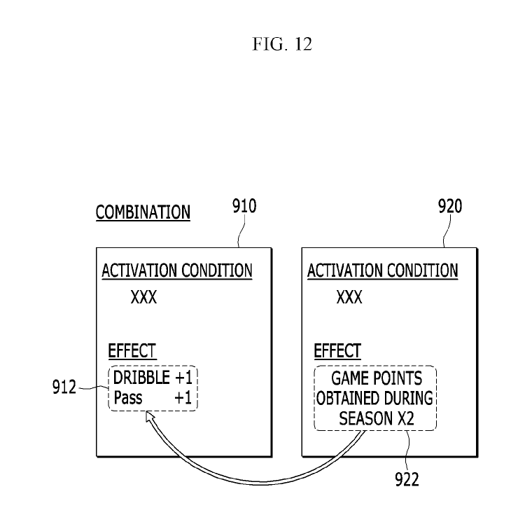

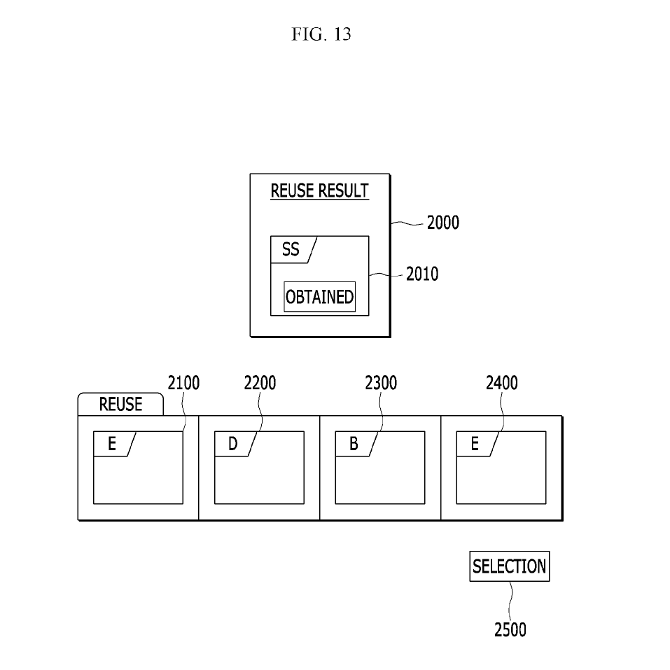

Further, the item managing module 220 serves to combine two or more auxiliary items, and serves to provide the user terminal 100 with a new auxiliary item that is made by reusing the auxiliary items. This will be described below in more detail with reference to FIG. 12 and FIG. 13.

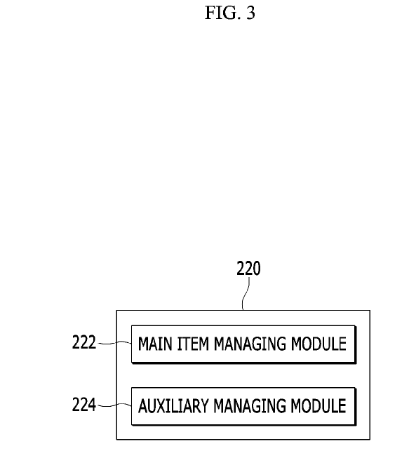

FIG. 3 is a diagram for describing an item managing module shown in FIG. 2 in more detail. Referring to FIG. 3, the item managing module 220 includes a main item managing module 222 and an auxiliary item managing module 224.

The main item managing module 222 serves to manage main items that are necessary for a corresponding game by a user.

For example, in the case of a soccer game, the user may select players to play a soccer game by using player card items (=main items) corresponding to an entry on the soccer game. In this case, ability values of these players are based on the ability values of the player card items.

The auxiliary item managing module 224 serves to manage auxiliary items for improving the ability values of the main items.

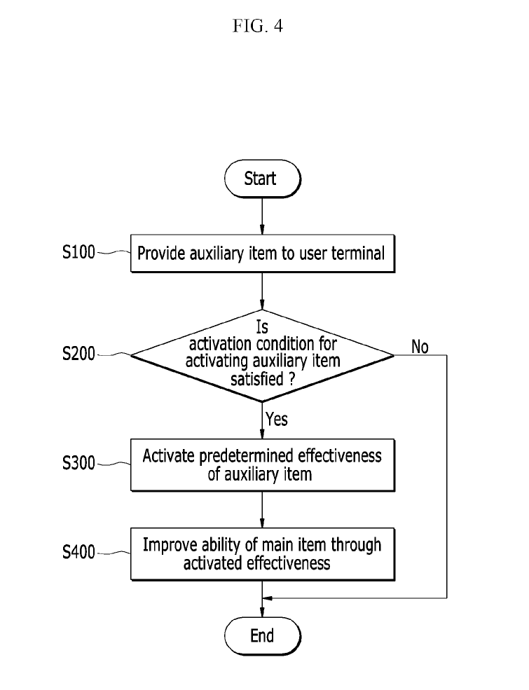

FIG. 4 is a flowchart showing a game service providing method using an auxiliary item in accordance with the present exemplary embodiment. The game service providing method using the auxiliary item can be realized by the server shown in FIG. 1.

Referring to FIG. 4, the server 200 may provide an auxiliary item to the user terminal 100 as necessary (S100). For example, when receiving a request for buying the auxiliary item from the user terminal 100, the server 200 may provide the auxiliary item to the user terminal 100. Further, when the user terminal 100 creates an account for the soccer game, the server 200 may provide an initial auxiliary item to the user terminal 100.

Next, the server 200 determines whether an activation condition for activating the auxiliary item in the user terminal 100 is satisfied (S200).

When the activation condition is satisfied, the server 200 activates a predetermined effectiveness of the auxiliary item (S300). The predetermined effectiveness includes various types of effectiveness for improving the ability of the main item (e.g., effectiveness of increasing an ability value A of the main item by +3, or effectiveness of increasing ability values A and B of the main item by +1).

The server 200 improves the ability of the main item by activating the predetermined effectiveness (S400). For example, when the predetermined effectiveness serves to increase the ability value A of the main item by +3, or serves to increase the ability values A and B of the main item by +1, the server 200 increases the ability value A of the main item by +3, or increases the ability values A and B of the main item by +1.

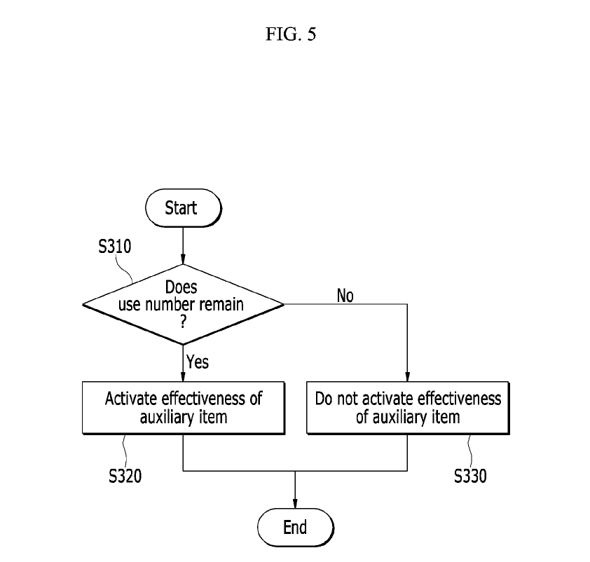

FIG. 5 is a flowchart for describing step S300 of FIG. 4 in more detail. Referring to FIG. 5, the server 200 determines whether the use number remains (S310) and, if the use number remains, activates the predetermined effectiveness of the auxiliary item S320.

If no use number remains, the server 200 does not activate the predetermined effectiveness of the auxiliary item (S330).

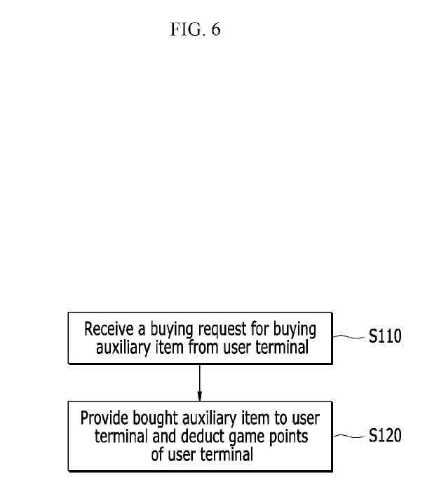

FIG. 6 is a flowchart for describing step S100 of FIG. 4 in more detail. Referring to FIG. 6, the server 200 may receive a request for buying the auxiliary item from the user terminal 100 (S110).

When receiving the buying request is received, the server 200 may provide the auxiliary item that is bought by the user terminal 100 thereto, and may deduct the game points held by the user terminal 100 (S120). In this case, the deducted game points may be varied according to the types of the auxiliary item that the user terminal 100 wants to buy, and the rule for determining how many points are deducted may be predetermined and stored in the server 200.

Further, in another exemplary embodiment, when an account for a game on the user terminal 100 is created, the server 200 may provide the user terminal 100 with any one of various types of the auxiliary item as one of initial basic items.

Hereinafter, the game service providing method using the auxiliary item in accordance with the exemplary embodiment of the present invention will be described in more detail with reference to FIG. 7 to FIG. 15.

FIG. 7 shows a main item in accordance with the present exemplary embodiment.

The main item 700 corresponds to a kind of player card of a soccer game. In the exemplary embodiment of the present invention, the soccer game needs a player, and the player corresponds to the player card. In this case, a player who participates in the soccer game may be varied according to whether to hold the player card. For example, when a user holds a first card for a player A but holds no second card for a player B, the player A is included in a soccer team of the user terminal 100 but the player B is not included in the soccer team.

The player card as the main card shown in FIG. 7 is C. Ronaldo, and his ability value is recorded.

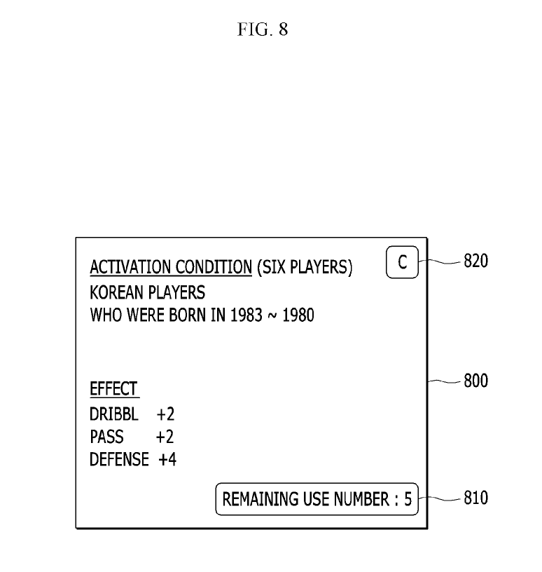

FIG. 8 shows an auxiliary item in accordance with the present exemplary embodiment.

The auxiliary item 800 serves to assist the performance of the player card corresponding to the main item 700. For example, as shown in FIG. 8, when an activation condition is satisfied in the user terminal 100 (e.g. when 6 Korean players who were born in 1983 to 1980 are held), ability values for dribble, pass, and defense in the player card of the main item held by the user terminal 100 are respectively upgraded by +2, +2, and +4.

Further, the auxiliary item 800 includes a remaining use number 810 and an item grade 820. The remaining use number 810 is related to how many times the auxiliary item 800 is used, and the item grade is related to a level of the effectiveness.

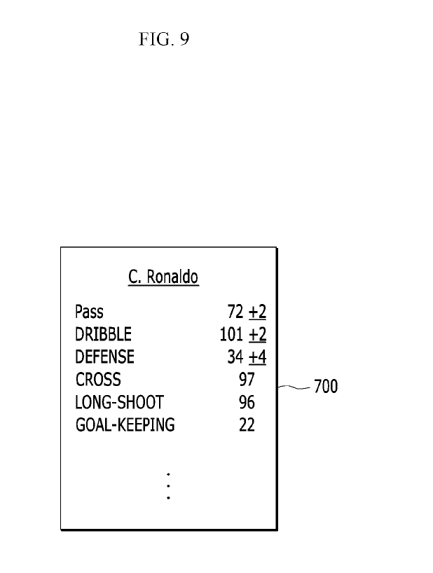

FIG. 9 shows a main item reflected with effectiveness of the auxiliary item in accordance with the present exemplary embodiment. When the activation condition of the auxiliary item 800 shown in FIG. 8 is satisfied and the auxiliary item is reflected to the player card 700 corresponding to the main item 700 of FIG. 7, the pass, the dribble, and the defense are respectively improved by +2, +2, and +4.

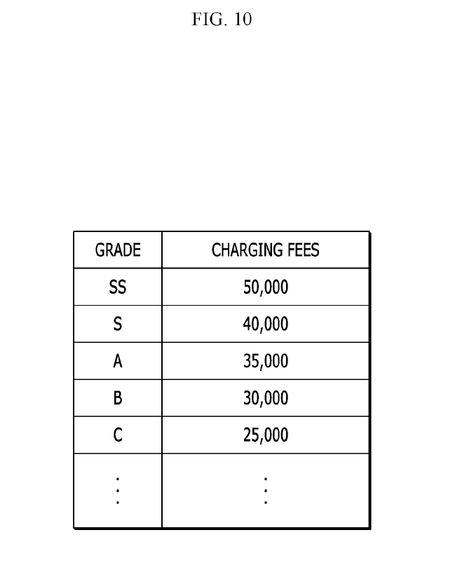

FIG. 10 shows charging fees of remaining use numbers of auxiliary items in accordance with the present exemplary embodiment of the present invention. The remaining use number of the auxiliary item 800 shown in FIG. 9 may be charged by deducting the game points of the user terminal 100.

As shown in a table of FIG. 10, the remaining use number may be charged by differently deducting the game points according to the grade of the auxiliary item 800.

Specifically, the charging fee according to the grade of the auxiliary item 800 ranging from a high level SS to a low level C may be pre-stored in the server 200, and the remaining use number of the auxiliary item 800 held by the user terminal 100 may be charged based on the table.

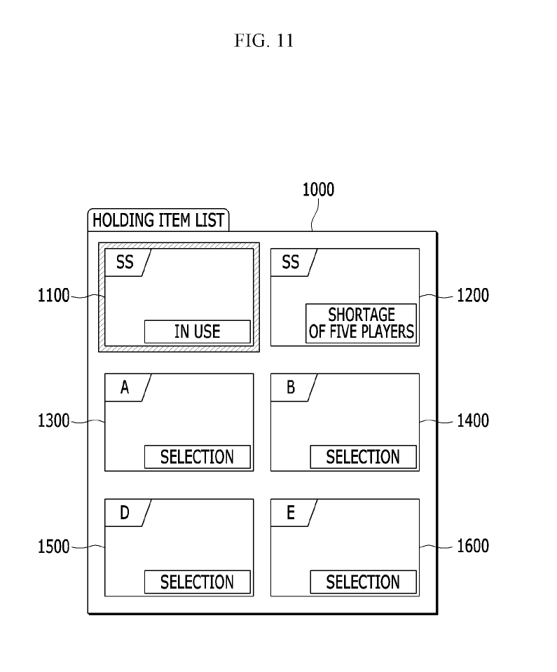

FIG. 11 shows a holding auxiliary item list of a user terminal in accordance with the present exemplary embodiment of the present invention. The holding auxiliary item list 1000 includes various auxiliary items 1100 to 1600.

In FIG. 11, the first auxiliary item 1100 is being used for the user terminal 100, and the second auxiliary item 1200 is not enabled to be activated since the activation condition is not satisfied due to a shortage of five players.

The third auxiliary item 1300, the fourth auxiliary item 1400, the fifth auxiliary item 1500, and the sixth auxiliary item 1600 can be activated according to user selections since their activation conditions are satisfied, but FIG. 11 illustrates a state in which the first auxiliary item 1100 is activated by a user.

As such, the server 200 may display the holding auxiliary item list 1000 on the user terminal 100 as shown in FIG. 11.

FIG. 12 is a view for describing a composition (or combination) of two or more auxiliary items in accordance with the present exemplary embodiment. Referring to FIG. 12, a first auxiliary item 910 and a second auxiliary item 920 are displayed on a screen.

For any two items of which kinds are not different from each other but the same as each other, one item may become the first auxiliary item 910, and the other item may become the second auxiliary item 920 according to selection of the user terminal 100. When the first auxiliary item 910 and the second auxiliary item 920 are combined, the first auxiliary item 910 is held by the user terminal 100, and the effect of the second auxiliary item 920 is provided to the first auxiliary item 910 and the second auxiliary item 920 itself disappears.

For example, when the first auxiliary item 910 and the second auxiliary item 920 are combined, the effect 912 of the first auxiliary item 910 may be changed to an effect 922 of the second auxiliary item 920. However, according to a predetermined possibility, the effect 912 of the first auxiliary item 910 may be maintained as it is without the change of effect, and the second auxiliary item 920 may disappear.

FIG. 13 is a view for describing reuse of the auxiliary item in accordance with the present exemplary embodiment of the present invention. The server 200 provides a service of reusing auxiliary items. Herein, reusing indicates a service of removing a predetermined number of auxiliary items that are not used by the user terminal 100 and providing a new auxiliary item having a new grade and a new attribute to the user terminal 100 instead.

Referring to FIG. 13, the user terminal 100 may select auxiliary items 2100 to 2400 that are not used. Then, when a selection button 2500 is pushed by the user terminal 100, the server 200 may output a new auxiliary item 2010 to a reuse result window 2000 and provide it to the user terminal 100.

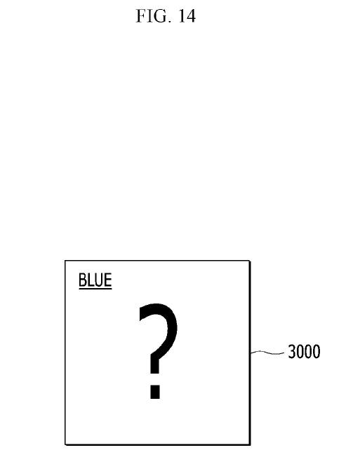

FIG. 14 is a view for describing a question-mark auxiliary item in accordance with the present exemplary embodiment. The server 200 may provide the question-mark auxiliary item 3000 to the user terminal 100 according to a buying request of the user terminal 100. Herein, the question-mark auxiliary item 3000 corresponds to a kind of auxiliary item to be provided to the user terminal 100. In this case, a user cannot know a grade, an activation condition, and an effect thereof before the user buy the auxiliary item.

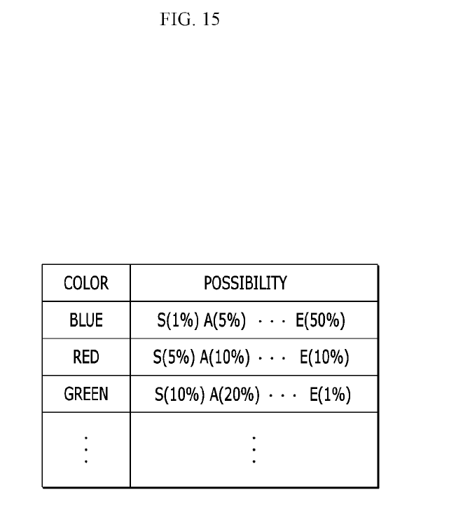

The question-mark auxiliary item 3000 may include various grades (e.g., blue, red, and the like), and when the user terminal 100 buys the question-mark auxiliary item 3000, the grade of an auxiliary item to be provided to the user terminal 100 may be determined according to a predetermined grade generating possibility. This will be described below in detail with reference to FIG. 15.

FIG. 15 is a table showing a grade generating possibility of the question-mark in accordance with the present exemplary embodiment of the present invention. Referring to FIG. 15, the grade generating possibility of the question-mark auxiliary item 3000 is differently set according to grades of the question-mark auxiliary item 3000 (e.g., red, blue, green, and the like) and is stored in the server 200. This is shown in a table of FIG. 5.

As such, by using the game service providing method using the auxiliary item in accordance with the exemplary embodiment of the present invention, a user can arouse his or her interest and keep playing a game. As a result, it is possible to provide a new type of service for preventing user game defection.

The method in accordance with the exemplary embodiment of the present invention as described above may be executed by the applications basically installed in the terminal (including programs included in a platform, an operating system, or the like which are basically installed in the terminal), and may also be executed by the applications (i.e., programs) which are directly installed in the terminal by the user via an application store server or an application store server such as a web server associated with the applications or the corresponding services. In this respect, the method for managing an item lottery service in accordance with the exemplary embodiments of the present invention may be implemented by the applications (i.e., programs) which are basically installed or directly installed by the user in the terminal and may be recorded in a computer readable recording medium of the terminal, and the like.

The programs are recorded in the computer readable recording medium and are executed by the computer, such that the above-mentioned functions may be executed.

As described above, in order for the computer to read the programs recorded in the recording medium and execute the method in accordance with the exemplary embodiment of the present invention, the above-mentioned programs may include codes which are coded with computer languages such as C, C++, JAVA, machine language, and the like which may be read by a processor (CPU) of the computer.

The code may include a function code associated with a function of defining the above-mentioned functions and may also include an execution procedure related control code required for the processor of the computer to execute the above-mentioned functions according to a predetermined procedure.

Further, the code may further include a memory reference related code indicating at which location (address number) of the memory inside or outside the computer additional information or media required for the processor of the computer to execute the above-mentioned functions need to be referenced.

Further, in order for the processor of the computer to execute the above-mentioned functions, when the processor needs to communicate with any other computers or servers, etc. at a remote location, the code may further include a communication related code about how the processor of the computer communicates with any other computers or servers at a remote location or which information or media the processor of the computer transmits and receives at the time of the communication, by using the communication module (for example, wired and/or wireless communication module) of the computer.

Further, a functional program for implementing the present invention, a code and a code segment associated therewith, and the like may be easily inferred or changed by programmers in the art to which the present invention pertains in consideration of a system environment of the computer which reads the recording medium and executes the program.

Hereinabove, examples of a computer readable recording medium recorded with programs as described above include a ROM, a RAM, a CD-ROM, a magnetic tape, a floppy disk, an optical media storage device, and the like.

Further, a computer readable recording medium recorded with programs as described above may be distributed to a computer system connected through a network and thus store and execute a computer readable code by a distributed manner. In this case, at least one computer among a plurality of distributed computers may execute a part of the above-mentioned functions and transmit the executed results to at least one of the other distributed computers, and the computer receiving the result may also execute a part of the above-mentioned functions and provide the executed results to the other distributed computers.

In particular, a computer readable recording medium recorded with applications, which are programs for executing method in accordance with the exemplary embodiment of the present invention, may be a storage medium (for example, hard disk, and the like) included in an application store server or an application providing server such as a web server associated with applications or corresponding services, and the like, or the application providing server itself.

A computer, which may read a recording medium recorded with applications that are programs for executing the method in accordance with the exemplary embodiment of the present invention, may include not only a general PC such as a typical desktop and a laptop but also a mobile terminal such as a smart phone, a tablet PC, personal digital assistants (PDAs), and a mobile communication terminal, and is to be construed as all the computable devices.

When a computer, which may read a recording medium recorded with applications that are programs for executing the method in accordance with the exemplary embodiment of the present invention, is a mobile terminal such as a smart phone, a tablet PC, a personal digital assistant (PDA), and a mobile communication terminal, the applications are downloaded from an application providing server to a general PC and thus may also be installed in the mobile terminal through a synchronization program.

Hereinabove, although it has been mentioned that all components configuring the exemplary embodiment of the present invention described hereinabove are combined with each other as one component or are combined and operated with each other as one component, the present invention is not necessarily limited to the above-mentioned exemplary embodiment. That is, all the components may also be selectively combined and operated with each other as one or more component without departing from the scope of the present invention.

In addition, although each of all the components may be implemented by one independent hardware, some or all of the respective components which are selectively combined with each other may be implemented by a computer program having a program module performing some or all of functions combined with each other in one or plural hardware. The codes and the code segments configuring the computer program may be easily inferred by a person having ordinary skill in the art to which the present invention pertains. The computer programs are stored in the computer readable media and are read and executed by the computer and may implement the exemplary embodiment of the present invention. As the storage medium of the computer programs, a magnetic recording medium, an optical recording medium, and the like may be used.

Further, it will be further understood that the terms “comprises” or “have” used in this specification may include the corresponding components unless explicitly described to the contrary and therefore, do not preclude other components but further include the components. In addition, unless defined otherwise in the detailed description, all the terms including technical and scientific terms have the same meaning as meanings generally understood by those skilled in the art to which the present invention pertains. Generally used terms such as terms defined in a dictionary should be interpreted as the same meanings as meanings within a context of the related art and should not be interpreted as ideally or excessively formal meanings unless clearly defined in the present specification.

The spirit of the present invention has been just exemplified. It will be appreciated by those skilled in the art that various modifications and alterations can be made without departing from the essential characteristics of the present invention. Accordingly, the exemplary embodiments disclosed in the present invention do not limit but describe the spirit of the present invention, and the scope of the present invention is not limited by the exemplary embodiments. The scope of the present invention should be interpreted by the following claims and it should be interpreted that all spirits equivalent to the following claims fall within the scope of the present invention.

1. A game service providing method using an auxiliary item, the method comprising:
by a server,
providing a user terminal with an auxiliary item for assisting a main item that is necessary for the user terminal;
determining whether an activation condition for activating the provided auxiliary item is satisfied;
when it is determined that the activation condition is satisfied,
activating a predetermined effectiveness of the auxiliary item of the user terminal; and
improving an ability of the main item through the effectiveness.

2. The game service providing method of claim 1, wherein the activating of the predetermined effectiveness includes:
when a use number of times at which the auxiliary item is to be used is determined according to a game play number of times at which a game was played,
determining whether the use number of the auxiliary item remains; and
when it is determined that the use number remains,
activating the effectiveness.

3. The game service providing method of claim 2, wherein the activating of the predetermined effectiveness includes:
when it is determined that no use number remains,
not activating the effectiveness and sending a notification that no use number remains to the user terminal.

4. The game service providing method of claim 3, further comprising:
receiving a charging request for charging the use number from the user terminal that receives the notification; and
when the charging request is received,
deducting game points held by the user terminal and charging the use number.

5. The game service providing method of claim 1, wherein the providing of the auxiliary item includes:
receiving a buying request for buying the auxiliary item from the user terminal; and
providing an auxiliary item that is requested to be bought by the user terminal to the user terminal and deducting game points of the user terminal.

6. The game service providing method of claim 4, wherein the deducted game points are differently set according to types of the auxiliary item that the user terminal wants to buy.

7. The game service providing method of claim 1, wherein the auxiliary item corresponds to a first auxiliary item, and
when the first auxiliary item is combined with a second auxiliary item, an effect of the first auxiliary item is changed to an effect of the second auxiliary item.

8. The game service providing method of claim 1, wherein the auxiliary item corresponds to an auxiliary item created by reusing a predetermined number of auxiliary items.

9. The game service providing method of claim 1, wherein the auxiliary item corresponds to a question-mark auxiliary item, and
the question-mark auxiliary item is one of auxiliary items that are provided to the user terminal, and an attribute of the auxiliary item is not known before the auxiliary item is bought.

10. The game service providing method of claim 9, wherein an attribute of the question-mark auxiliary item generated after the question-mark auxiliary item is bought is determined based on a table showing a grade generating possibility of the question-mark auxiliary item that is pre-stored in the server.

11. A server for providing a game service using an auxiliary item, the server comprising:
a transceiving module configured to provide a user terminal with an auxiliary item for assisting a main item that is necessary for the user terminal;
a determining module configured to whether an activation condition for activating the provided auxiliary item is satisfied; and
an item managing module configured to manage the main item and the auxiliary item and, when it is determined that the activation condition is satisfied, activate a predetermined effectiveness of the auxiliary item of the user terminal and improve an ability of the main item through the effectiveness.

12. The server of claim 11, wherein, when a use number of times at which the auxiliary item is to be used is determined according to a game play number of times at which a game was played, the determining module determines whether the use number of the auxiliary item remains, and
when it is determined by the determining module that the use number of the auxiliary item remains,
the item managing module activates the effectiveness.

13. The server of claim 12, wherein, when it is determined by the determining module that no use number of the auxiliary item remains, the item managing module does not activate the effectiveness.

14. The server of claim 13, wherein the transceiving module receives a charging request for charging the use number from the user terminal, and
the server further comprises, when the charging request is received through the transceiving module, a charging module configured to deduct game points held by the user terminal and charge the use number.

15. A computer readable recording medium recorded with program for executing a game service providing method,
wherein the method includes:
by a server,
providing a user terminal with an auxiliary item for assisting a main item that is necessary for the user terminal;
determining whether an activation condition for activating the provided auxiliary item is satisfied;
when it is determined that the activation condition is satisfied,
activating a predetermined effectiveness of the auxiliary item of the user terminal; and
improving an ability of the main item through the effectiveness.
